(19) United States
(12) Patent Application Publication
(10) Pub. No.: US 2007/0208921 A1
(43) Pub. Date: Sep. 6, 2007

(54) Storage system and control method for the same

(75) Inventors: Masaaki Hosouchi, Zama (JP); Yuri Hiraiwa, Sagamihara (JP); Nobuhiro Maki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/408,667

(22) Filed: Apr. 21, 2006

(30) Foreign Application Priority Data
Mar. 3, 2006 (JP) 2006-058567

(51) Int. Cl. G06F 12/00; G06F 1/32; G06F 12/16

(52) U.S. Cl. 711/170; 713/320; 711/114

(57) ABSTRACT

When a storage system receives a request from a host computer to read data from a logical unit, the storage system selects a logical device from which data is to be read, in accordance with the power supply status and power-off time for each logical device allocated to the logical unit, turns on the power supply for the selected logical device, and reads data from that device. When the storage system receives a request from a host computer to write data to a logical unit, it turns on the power supply for each logical device allocated to the logical unit and performs multiplex-writing of data for each logical device.

### CROSS-REFERENCES TO RELATED APPLICATIONS

This application relates to and claims priority from Japanese Patent Application No. 2006-58567, filed on Mar. 3, 2006, the entire disclosure of which is incorporated herein by reference.

### BACKGROUND OF THE INVENTION

The present invention relates to a storage system that provides a host computer with a logical volume multiplexed with a plurality of logical devices, and a control method for the same.

In recent years, data life cycle management (DLCM) has been attracting attention as a method for managing a storage system. DLCM is a concept realizing a more cost efficient data management method by managing data migration between storage systems according to the value of data changing with time. For instance, since an email system is positioned as a mission-critical enterprise system, it is necessary to use a high-end storage system having high performance and high reliability. Since access frequency will decrease for email that is a few weeks old, data is migrated from the high-end storage system to a nearline storage system. Although a nearline storage system is inferior to a high-end storage system in terms of performance and reliability, it has merit in that it is inexpensive, and instant access is possible as required. After 1 to 2 years have elapsed since the migration of data to the nearline storage system, the data is migrated to a tape medium and stored in a cabinet.

As technology for taking the concept of DLCM one step further, a technology referred to as MAID (Massive Arrays of Inactive Disks) is known for reducing the power consumption in a storage system by stopping the rotation of disk drives that are not frequently accessed or by turning off the power supply to those disk drives. For example, Japanese Patent Laid-Open Publication No. 2005-157710 discloses technology for a storage system to turn on/off the power supply for a disk drive constituting a logical volume the storage system provides, in response to an instruction from a computer connected to the storage system.

### SUMMARY OF THE INVENTION

However, if a disk drive is frequently switched on/off, or if the rotation of a disk drive is frequently started/stopped, that accelerates the disk drive's degradation with time, resulting in an increase in both the failure probability and power consumption. So, it is better to not frequently switch a disk drive on/off, or frequently start/stop its rotation.

For example, where the same data is distributed and stored in a plurality of disk drives so that the data can be read from any disk drive, if the data is read evenly from every disk drive, the frequency of each disk drive being switched on/off will increase, causing a problem involving an increase in the disk drive failure probability and power consumption.

Also, although it is necessary to stop the rotation of a disk drive or turn off its power supply in order to reduce the power consumption based on the MAID technology, the occurrence of a disk drive failure cannot be detected until the disk drive is activated or accessed for data. If disk drives are in a power-off state for a long period of time, no disk drive failure can be detected during that power-off period, even if a number of disk drive failures occur and these exceed the maximum disk drive failures acceptable in terms of data recovery; thus the risk of data loss will increase.

Accordingly, this invention concerns a storage system that turns on/off the power supply for disk drives in accordance with how frequently each disk drive is accessed, and aims at, in the above storage system, reducing the frequency of each disk drive being switched on/off as well as the proportion of disk drives that have been powered on in a plurality of disk drives. This invention further aims at reducing the data loss probability in the above storage system.

In order to achieve the foregoing objects, a storage system according to this invention has a plurality of disk drives providing a storage area for a plurality of logical devices, and provides a host computer with a logical volume multiplexed with a plurality of logical devices. When this storage system receives a request from the host computer to read data from the logical volume, it selects a logical device from which data is to be read, in accordance with the power supply status and power-off time for each logical device allocated to the logical volume from which data-read has been requested; turns on a power supply for the selected logical device; and reads data from the selected logical device. Also, when this storage system receives a request from the host computer to write data to the logical volume, it turns on the power supply for each logical device allocated to the logical volume to which data-write has been requested; and performs multiplex-writing for each logical device allocated to that logical volume.

For example, if the plurality of logical devices allocated to the logical volume from which data-read has been requested is in a power-off state, the storage system selects the logical device having the oldest power-off time from among the plurality of logical devices allocated to the logical volume from which data-read has been requested; turns on the power supply for the selected logical device; and reads data from the selected logical device. Accordingly, it is possible to reduce the incidence of a particular disk drive being in a power-off state for a long period of time, and even if a failure occurs during the power-off period, that failure can be detected at an earlier stage.

For example, if some of the plurality of logical devices allocated to the logical volume from which data-read has been requested is in a power-on state, the storage system reads data from any of the powered-on logical devices. Accordingly, it is possible to reduce the frequency of a disk drive being switched on/off, and also reduce the proportion of disk drives that have been powered on in a plurality of disk drives.

For example, if the plurality of logical devices allocated to the logical volume from which data-read has been requested is in a power-off state, the storage system selects a logical device having a time difference between its power-off time and the time the data read request was received exceeding a predetermined maximum allowable period of time; turns on the power supply for the selected logical device; and reads data from the selected logical device. Accordingly, it is possible to reduce the incidence of a particular disk drive being in a power-off state for a long period of time, and even if a failure occurs during the power-off period, that failure can be detected at an earlier stage.

According to the invention, in a storage system that turns on/off the power supply for disk drives in accordance with how frequently each disk drive is accessed, it is possible to reduce the frequency of each disk drive being switched on/off, and also reduce the proportion of disk drives that have been powered on in a plurality of disk drives. It is also possible to reduce the probability of data loss caused by disk drive failures.

### BRIEF DESCRIPTION OF THE DRAWINGS

FIG. 1 is the hardware configuration of a computer system according to Embodiment 1 of the invention;

FIG. 2 is a functional block diagram concerning control processing in the computer system;

FIG. 3 is a time chart outlining the processing for determining a logical device from which data is to be read, based on the power supply status and the power-off time;

FIG. 4A-4B are explanatory diagrams of a logical unit management table;

FIG. 5A-5B are explanatory diagrams of a logical device management table;

FIG. 6 is an explanatory diagram of a power supply control group management table;

FIG. 7 is a flowchart showing multiplicity instruction processing;

FIG. 8 is a flowchart showing multiplicity setting processing;

FIG. 9 is a flowchart showing logical device multiplex allocation processing;

FIG. 10 is a flowchart showing logical device de-allocation processing;

FIG. 11 is a flowchart showing multiplexed volume output processing;

FIG. 12 is a flowchart showing power supply control processing;

FIG. 13 is a flowchart showing multiplexed volume input processing;

FIG. 14 is the hardware configuration of a computer system according to Embodiment 2;

FIG. 15 is a flowchart showing storage system addition processing; and

FIG. 16 is a flowchart showing logical device migration processing.

### DETAILED DESCRIPTION OF THE INVENTION

Embodiments of the present invention are explained below with reference to the attached drawings. Each embodiment does not limit the scope of the claims, and the invention does not necessarily need to have all the features explained in the embodiments as means for achieving the objects of the invention.

### Embodiment 1

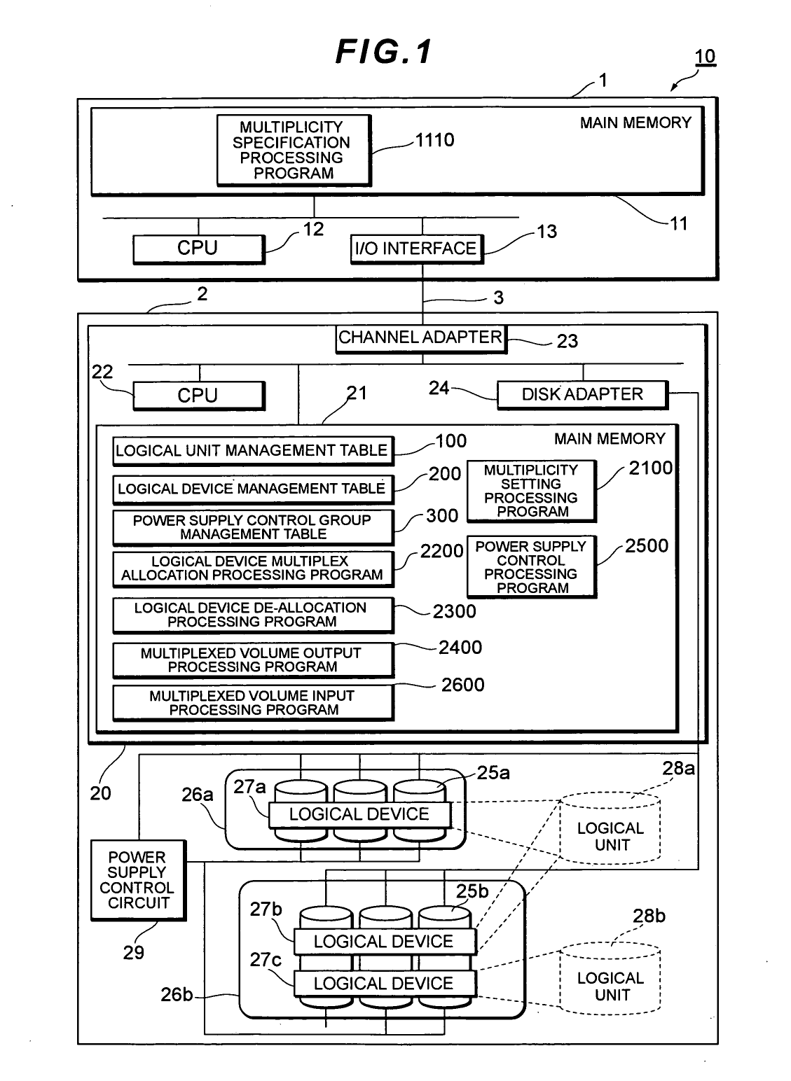

FIG. 1 shows the hardware configuration of a computer system 10 according to Embodiment 1. The computer system 10 includes a host computer 1 and a storage system 2. The host computer 1 and the storage system 2 are connected via a communication network 3. The communication network 3 is, for example, a SAN (Storage Area Network), LAN (Local Area Network), WAN (Wide Area Network), internet, dedicated line, public line, or similar.

The host computer 1 includes a main memory 11, a CPU 12 and an I/O interface 13. The CPU 12 loads, interprets and executes the instruction code in a multiplicity instruction processing program 1100 stored in the main memory 11. The I/O interface 13 is an interface for accessing the storage system 2 via the communication network 3, and it is, for example, a host bus adapter or similar.

The multiplicity instruction processing program 1100 instructs the storage system 2 about the multiplicity for a logical volume, which is a logical storage area recognized by the host computer 1, or the multiplicity for a file stored in a logical volume. The details of the multiplicity instruction processing program 1100 are explained later.

The storage system 2 includes a controller 20, a plurality of disk drives 25a and 25b, and a power supply control circuit 29. The controller 20 includes main memory 21, a CPU 22, a channel adapter 23 and a disk adapter 24. The main memory 21 stores a logical unit management table 100, a logical device management table 200, a power supply control group management table 300, a multiplicity setting processing program 2100, a logical device multiplex allocation processing program 2200, a logical device de-allocation processing program 2300, a multiplexed volume output processing program 2400, a power supply control processing program 2500, and a multiplexed volume input processing program 2600. The CPU 22 loads the respective processing programs 2100 to 2600 from the main memory 21, and interprets and executes them. The channel adapter 23 is a host interface for transmitting I/O data between the host computer 1 and the storage system 2 via the communication network 3, and receiving multiplicity instructions issued by the host computer 1. The details of the multiplicity instruction are explained later. The disk adapter 24 is a drive interface for transmitting data between the CPU 22 and the disk drives 25a and 25b.

The storage system 2 may include a plurality of controllers 20. The controller 20 may include a plurality of channel adapters 23 or a plurality of disk adapters 24.

The disk drives 25a and 25b are each physical devices having a physical storage area for storing data, and they are, for example, an FC (Fibre Channel) disk drive, SATA (Serial Advanced Technology Attachment) disk drive, PATA (Parallel Advanced Technology Attachment) disk drive, FATA (Fibre Attached Technology Adapted) disk drive, SCSI (Small Computer System Interface) disk drive, or other such storage devices.

A RAID group 26a is defined by grouping logical storage areas provided by each of the plurality of disk drives 25a. For example, a RAID group 26a is defined as a logical storage area by grouping four disk drives 25a to form one group (3D+1P), or by grouping eight disk drives 25a to form one group (7D+1P). A logical device 27a is defined in the storage area of the RAID group 26a. In other words, the logical device 27a is a storage area including one or more storage areas defined by logically dividing the physical storage area that one or more disk drives 25a have. Data stored in the logical device 27a and the parity generated from that data is distributed among the plurality of disk drives 25a and stored there.

A RAID group 26b is defined by grouping logical storage areas provided by each of the plurality of disk drives 25b. For example, by grouping four disk drives 25b to form one group (3D+1P), or by grouping eight disk drives 25b to form one group (7D+1P), a RAID group 26b can be defined as a logical storage area. Logical devices 27b and 27C are defined in the storage area of the RAID group 26b. In other words, each of the logical devices 27b and 27c is a storage area including one or more storage areas defined by logically dividing the physical storage area that one or more disk drives 25b have. Data stored in the logical devices 27b and 27c and the parity generated from that data is distributed among the plurality of disk drives 25b and stored there.

Each of the logical devices 27a and 27b is assigned a logical device ID for uniquely identifying the logical device 27a or 27b within the storage system 2. The logical device ID is, for example, a logical device number (LDEV#).

A logical unit 28a is a logical storage area with a plurality of logical devices 27a and 28b allocated, while a logical unit 28b is a logical storage area with a single logical device 27c allocated. For ease of explanation, here, a configuration is described where the logical unit 28a is multiplexed by the plurality of logical devices 27a and 27b but the logical unit 28b isn't, but the invention is not limited to that configuration. The host computer 1 recognizes the logical units 28a and 28b each as one logical volume. Each of the logical units 28a and 28b is assigned a logical unit ID as their unique identifier within the controller 20. The logical unit ID is, for example, a CCA (Channel Connection Address), or LUN (Logical Unit Number).

If a host computer 1 is a UNIX®-based system, logical units 28a and 28b are associated with device files. If a host computer 1 is a Windows®-based system, logical units 28a and 28b are associated with drive letters (drive names).

A logical volume ID, which is an identifier whereby a program in the host computer 1 can uniquely identify a logical volume, is defined as one different from the logical unit ID. The logical volume ID is, for example, a device number (DEVN) or device name (e.g., /dev/had). The relationship between a logical volume ID and a logical unit ID is defined by the host computer 1 administrator in a device setting file (not shown in the drawing) in the host computer 1. The device setting file is read onto the main memory 11 when the host computer 1 is booted up.

In the below explanation, if it is not necessary to distinguish disk drives 25a and 25b, just disk drives 25 are used. Also, if it is not necessary to distinguish RAID groups 26a and 26b, just one RAID group 26 is used, and if it is not necessary to distinguish logical devices 27a and 27b, just one logical device 27 is used. Moreover, if it is not necessary to distinguish logical units 28a and 28b, just one logical unit 28 is used.

The power supply control circuit 29 performs the on/off control of the power supply for each disk drive 25 on a power supply control group basis. The power supply control group is a group of disk drives 25 prepared for power supply control, and the power supply for all disk drives 25 in a power supply control group is tuned on/off at the same time by the power supply control circuit 29. If the disk drives 25 are configured based on RAID, the power supply control group is composed of one or more RAID groups. If the disk drives 25 are not configured based on RAID, the power supply control group is composed of one or more disk drives 25. The power supply control circuit 29 functions to inform the CPU 22 of the power supply status (power on/off state) of a particular power supply control group in response to an instruction from the CPU 22.

Instead of controlling the power on/off state of each disk drive 25, the power supply control circuit 29 may control rotation starting/stopping for each disk drive 25. Where the power supply control circuit 29 controls starting/stopping the disk drive 25 rotation, “turning on the power supply for the disk drive 25” and “turning off the power supply for the disk drive 25” in the below-explained processes should be replaced with “starting the rotation of the disk drive 25” and “stopping the rotation of the disk drive 25” respectively.

The power supply control circuit 29 attempts to reduce power consumption by turning off the power supply for the disk drives 25 that provide a storage area for a logical unit 28 that has not been accessed frequently or has not been accessed for a long period of time. However, if the disk drives 25 are in a power-off state for a long period of time, no failure in the disk drives 25 can be detected during that power-off period, even if failures occur in a number of disk drives 25 and these exceeds the maximum number acceptable in terms of data recovery; thus the risk of data loss will increase. In order to solve the above problem, a logical unit 28 is multiplexed by allocating a plurality of logical devices 27 to one logical unit 28. When the host computer 1 requests data-read from a logical unit 28, the controller 20 selects one logical device 27 from among the logical devices 27 allocated to that logical unit 28, based on the power supply status of each logical device 27 and the time the power supply for each logical device 27 was turned off, and reads data from the selected logical device 27. A logical device multiplex allocation processing program 2200 executes processing for multiplexing the logical unit 28 with a plurality of the logical devices 27. A multiplexed volume output processing program 2400 executes processing for writing data to a logical unit 28 that is multiplexed with a plurality of logical devices 27. A multiplexed volume input processing program 2600 executes processing for reading data from a logical unit 28 that is multiplexed with a plurality of logical devices 27.

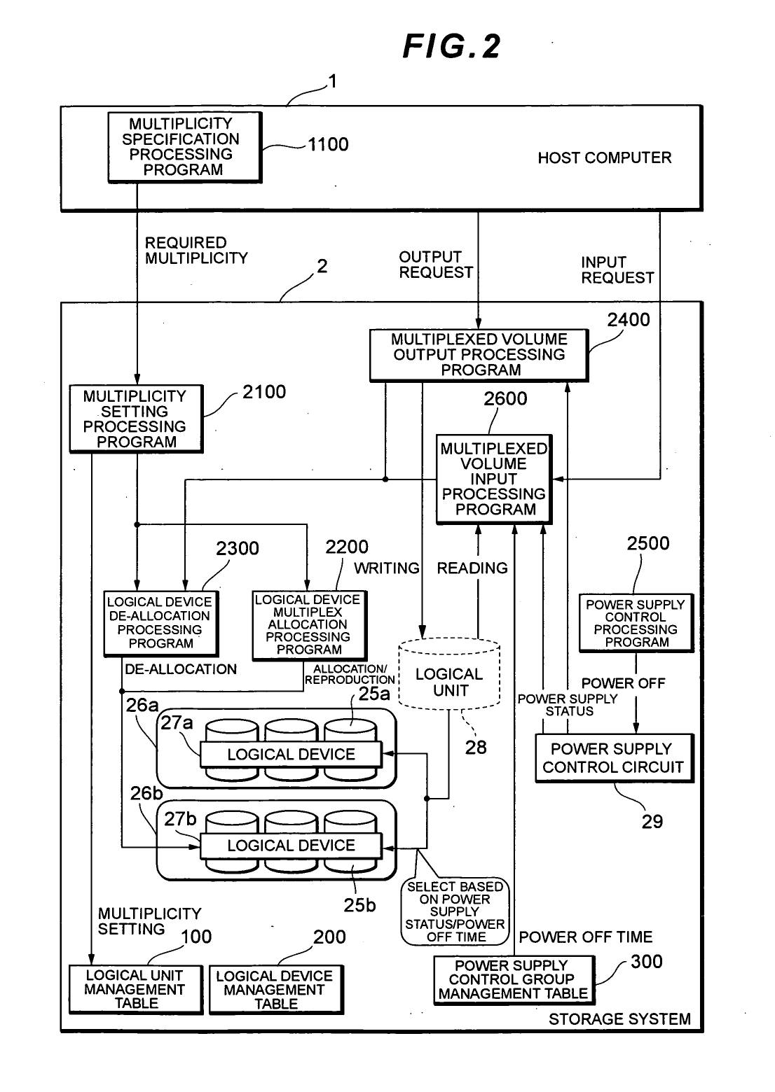

FIG. 2 shows the functional blocks related to the control processing in the computer system 10. The CPU 12 in the host computer 1 reads the instruction code in the multiplicity instruction processing program 1100, and interprets and executes it. The CPU 12, executing the multiplicity instruction processing program 1100, requires the controller 20 in the storage system 2 to multiplex a particular logical unit 28, specifying the number of logical devices 27 to be allocated to the logical unit 28 (required multiplicity), based on the storage class given to the relevant logical volume or file.

In response to a request to multiplex a logical unit 28, the CPU 22 in the controller 20 reads the instruction code in the multiplicity setting processing program 2100, and interprets and executes it. The CPU 22, executing the multiplicity setting processing program 2100, records the required multiplicity in the logical unit management table 100, and also reads, interprets and executes the instruction code in the logical device multiplex allocation processing program 2200.

The CPU 22, executing the logical device multiplex allocation processing program 2200, searches the logical device management table 200 for any unallocated logical device 27, and allocates the retrieved logical device 27 to the logical unit 28. The CPU 22 also records the logical device ID of the logical device 27 that has been allocated to the logical unit 28 in the logical unit management table 100. The CPU 22 reproduces data stored in the other logical device(s) 27 already allocated to the logical unit 28, in the new logical device 27 that has now been allocated to that logical unit 28, so that the same data is stored in all logical devices 27 allocated to the logical unit 28.

If the host computer 1 requests writing of data to a logical unit 28 that is multiplexed with a plurality of logical devices 27, the CPU 22 in the storage system 2 reads, interprets and executes the instruction code in the multiplexed volume output processing program 2400, and performs multiplex data-writing so that the content of each of the logical devices 27 allocated to the logical unit 28 to which writing of data has been requested matches. After writing data to the logical unit 28, if no access has been made for a predetermined period of time for all logical devices 27 that are allocated to any disk drive 25 included in the same power supply control group, the CPU 22 reads, interprets and executes the instruction code in the power supply control processing program 2500, instructs the power supply control circuit 29 to turn off the power supply for all the disk drives 25 included in the same power supply control group, and updates the power supply status and power-off time recorded in the power supply control group management table 300.

Meanwhile, if the host computer 1 requests data-read from a logical unit 28 that is multiplexed with a plurality of logical devices 27, the CPU 22 in the storage system 2 reads the instruction code in the multiplexed volume input processing program 2600, interpreting and executing it, and checks the power supply control group management table 300 to retrieve the power supply status and power-off time regarding each logical device 27 allocated to the logical unit 28 from which data-read has been requested. The CPU 22 then selects one logical device 27 in accordance with the power supply status and power-off time for each logical device 27, and reads data from the selected logical device 27.

If the host computer 1 instructs the storage system 2 to change the required multiplicity for a logical unit 28, the CPU 22 in the storage system 2 reads the instruction code in the logical device de-allocation processing program 2300, interprets and executes it, and releases one or more logical devices 27 from among the plurality of logical devices allocated to that logical unit 28.

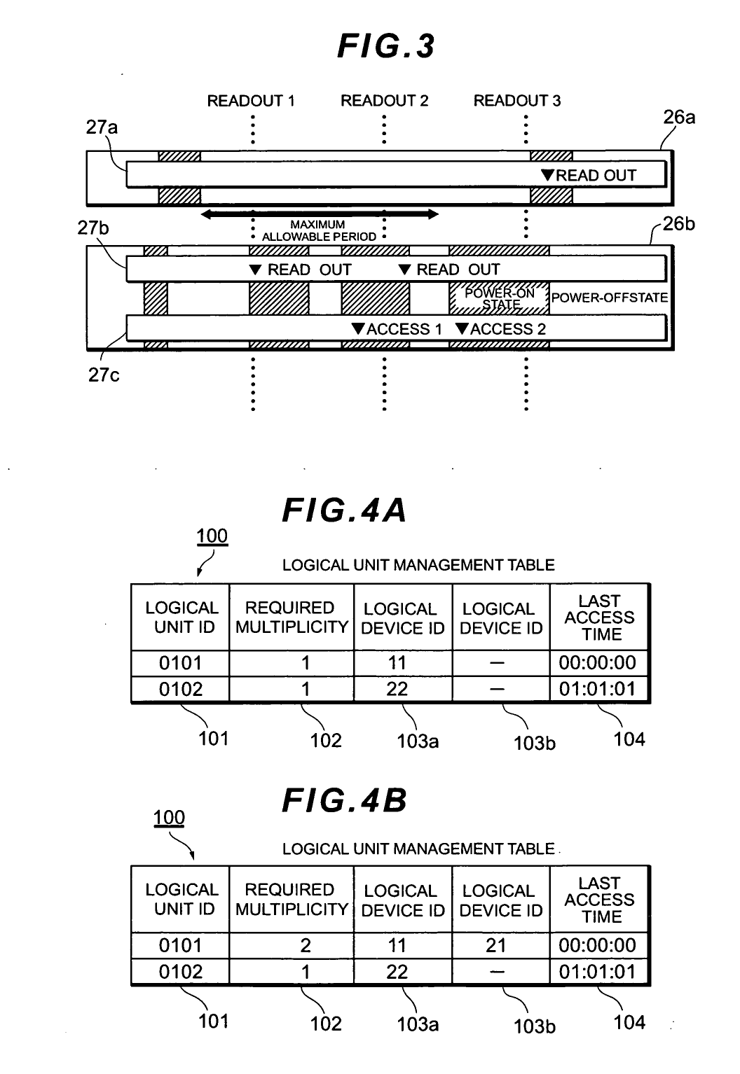

FIG. 3 is a time chart outlining the processing for determining a logical device 27 from which data is to be read, based on the power supply status and power-off time. In FIG. 3, portions with shading indicate a power-on state, and portions without shading indicate a power-off state. For the sake of simplified explanation, a RAID group 26 is assumed as having one-to-one correspondence with a power supply control group in the below explanation. More specifically, a logical device 27a included in a RAID group 26a and a logical device 27b included in a RAID group 26b belong to different power supply control groups. Also, the logical device 27b included in the RAID group 26b and a logical device 27c included in the RAID group 26b belong to the same power supply control group. The power supply for the logical devices 27a and 27b belonging to the different power supply control groups is turned on/off at different times. Meanwhile, the power supply for the logical devices 27b and 27c belonging to the same power supply control group is turned on/off at the same time. Like in the above explanation, a plurality of logical devices 27a and 27b is allocated to a logical unit 28a, and a single logical device 27c is allocated to a logical unit 28b.

At the “readout 1” point in time, where the host computer 1 requests reading of data from the logical unit 28a, the disk drives 25a providing a storage area for the logical device 27a and the disk drives 25b providing a storage area for the logical device 27b, both being allocated to the logical unit 28a, are both in a power-off state. When a request is made to read data from a logical unit 28 multiplexed with a plurality of logical devices 27, if all logical devices 27 allocated to that read request target logical unit 28 are in a power-off state, the CPU 22 refers to the power supply control group management table 300, selects the logical device 27 with the oldest power-off time from among the plurality of logical devices 27, and reads data from the selected logical device 27. If the period that the disk drives 25 are in a power-off state becomes longer, the possibility of a failure occurring during that power-off period and then being discovered increases. Accordingly, it is better to reduce the power-off period of the disk drives 25 as much as possible. In the example shown in FIG. 3, since the time that the power supply for the logical device 27b was turned off was before that of the logical device 27a, the CPU 22 turns on the power supply for the logical device 27b and reads data from the logical device 27b. If the logical device 27b is not accessed for a predetermined period of time after the data is read, the CPU 22 turns off the power supply for the logical device 27b.

At the “readout 2” point in time, where the host computer 1 requests reading of data from the logical unit 28a, the disk drives 25a providing a storage area for the logical device 27a and the disk drives 25b providing a storage area for the logical device 27b, both being allocated to the logical unit 28a, are in a power-off state and a power-on state respectively. Because the CPU 22 reads data from the logical device 27c at the “access 1” point in time, the power supply for the logical device 27b, which belongs to the same power supply control group as the logical device 27c, is also turned on at the “access 1” point in time When a request is made to read data from a logical unit 28 multiplexed with a plurality of logical devices 27, if some of the plurality of the logical devices 27 allocated to that read request target logical unit 28 are in a power-on state and others in a power-off state, the CPU 22 refers to the power supply control group management table 300, selects a logical device 27 that is in a power-on state, and reads data from the selected logical device 27. As a result, since it is not necessary to frequently turn on/off the power supply for the disk drives 25 every time data read requests are made, power consumption can be reduced. In the example shown in FIG. 3, the CPU 22 selects the logical device 27b that is in a power-on state at the “readout 2” point in time and reads data from that selected logical device 27b.

When a request is made to read data from a logical unit 28 multiplexed with a plurality of logical devices 27, and some of the plurality of logical devices 27 allocated to the read request target logical unit 28 are in a power-on state and others are in a power-off state; however, always reading data from a specific logical device 27 results in the other logical devices 27 being in a power-off state for a longer period of time, leading to a possibility that any failure that may occur in a disk drive 25 during the power-off period will remain undiscovered. So when the host computer 1 sends a request to read data from a logical unit 28, and if a plurality of logical devices 27 allocated to the logical unit 28 includes a logical device 27 with a power-off period exceeding a predetermined length (hereinafter referred to as “maximum allowable period”), the CPU 22 selects that logical device 27 that has been powered-off for a period exceeding the maximum allowable period, even if another logical device 27 is in a power-on state, and reads data from the selected logical device 27. As a result, any failure that may occur in a disk drive 25 during the power-off period can be discovered at an earlier stage. In the example shown in FIG. 3, at the “readout 3” point in time, where the host computer 1 requests data-read from the logical unit 28a, even though the logical device 27b is in a power-on state, the power-off period of the logical device 27a exceeds the maximum allowable period, so the CPU 22 turns on the power supply for the logical device 27a while turning off the power supply for the logical device 27b, and reads data from the logical device 27a.

The maximum allowable period may be a period of time set by a designer of the storage system 2 in advance, for example based on the correlation between the power-off period of a disk drive 25 and its failure rate. The maximum allowable period may also be specified by users.

As explained above, when a read request is directed to a logical unit 28 multiplexed by a plurality of logical devices 27, the CPU 22 selects one logical device 27 from which data is to be read, in accordance with the power supply status and power-off time for each logical device 27, as well as whether the maximum allowable period has lapsed or not, and reads data from the selected logical device 27. Accordingly, it is possible to reduce the frequency of switching on/off the disk drives 25, and also reduce the possibility of a prolonged power-off period, enabling any failure to be discovered at an earlier stage.

In multiplexing a logical unit 28 with a plurality of logical devices 27, the logical devices 27 are preferably included in different power supply control groups wherever possible. By distributing the plurality of logical devices 27 allocated to the logical unit 28 in different power supply control groups, the probability that any of the plurality of logical devices 27 allocated to the logical unit 28 is in a power-on state if a read request is directed to the logical unit 28 increases. Consequently, the frequency of switching on/off the disk drives 25 can be reduced.

Since different types of disk drives 25 (such as FC disk drives or SATA disk drives) have different reliability (or failure rates), it is prudent to set a suitable maximum allowable period according to the types of the disk drives 25. For example, a longer-term maximum allowable period may be set for higher-reliability FC disk drives while having a shorter-term maximum allowable period for lower-reliability SATA disk drives.

Alternatively, the maximum allowable period may be set according to the run time of the disk drives 25. The run time means the total of the period of time that the disk drives 25 are in a power-on state and the period of time that the disk drives 25 are in a power-off state. The longer the run time is, the more the failure rate of the disk drives 25 is likely to increase, so it is better to check for failures at short time intervals. So it is preferable to set a longer maximum allowable period for disk drives 25 with a longer run time than for disk drives 25 with a shorter run time. One example is sectioning a run time with a specific length of time T, and setting a maximum allowable period for each length of the run time based on the above T (Run Time T, Run Time 2T, . . . , Run Time nT, where n is a positive integer) in the memory (the main memory 21 or other nonvolatile memory) within the storage system 2.

Also, since a logical unit 28 storing data with a high level of importance should be checked for failures more frequently than a logical unit 28 storing data with a low level of importance, it is better to change the maximum allowable period according to the level of importance of data stored in each logical unit 28. For example, the maximum allowable period for disk drives 25 providing a storage area for a logical unit 28 that stores data with a high level of importance is set to be shorter than that for disk drives 25 providing a storage area for a logical unit 28 that stores data with a low level of importance. The maximum allowable period may also be set for each logical unit 28 in a similar way to setting the multiplicity for each logical unit 28. Note, however, that if the maximum allowable period is set for each logical unit 28, there is a possibility that the disk drives 25 having different maximum allowable periods will be included in the same power supply control group. If this happens, the shortest maximum allowable period in a plurality of disk drives 25 included in the same power supply control group should be established as the maximum allowable period for that power supply control group.

FIGS. 4A and 4B show the configuration of the logical unit management table 100. The logical unit management table 100 has a plurality of entries 110a and 110b. The entry 110a manages the logical unit 28a and the entry 110b manages the logical unit 28b. The entries 110a and 110b respectively include a logical unit ID 101, a required multiplicity 102, logical device IDs 103a and 103b, and a last access time 104.

The logical device IDs 103a and 103b are the identifiers for each logical device 27 if a plurality of logical devices 27 is allocated to a logical unit 28. The last access time 104 is the latest time that the host computer 1 write/read-accessed the logical unit 28. The last access time 104 may also be the time that the path between the host computer 1 and the logical unit 28 went off-line (hereinafter referred to as an “off-line time”). If the off-line time is used as the last access time 104, the last access time 104 will be reset when the path between the host computer 1 and the logical unit 28 goes off-line.

In the below explanation, if it is not necessary to distinguish entries 110a and 110b, just one entry 110 is used. If it is not necessary to distinguish logical device IDs 103a and 103b, just one logical device ID 103 is used. If three or more logical devices 27 are allocated to a logical unit 28, the relevant entry 110 stores three or more logical device IDs 103.

FIG. 4A shows the logical unit management table 100 where just the logical device 27a is allocated to the logical unit 28a, while FIG. 4B shows the logical unit management table 100 after a plurality of logical devices 27a and 27b has been allocated to the logical unit 28a. If one logical device 27 is added to the logical unit 28a, the required multiplicity of the entry 110a is changed from “1” to “2,” and the logical device ID of the added logical device 27b is entered as the logical device ID 103b.

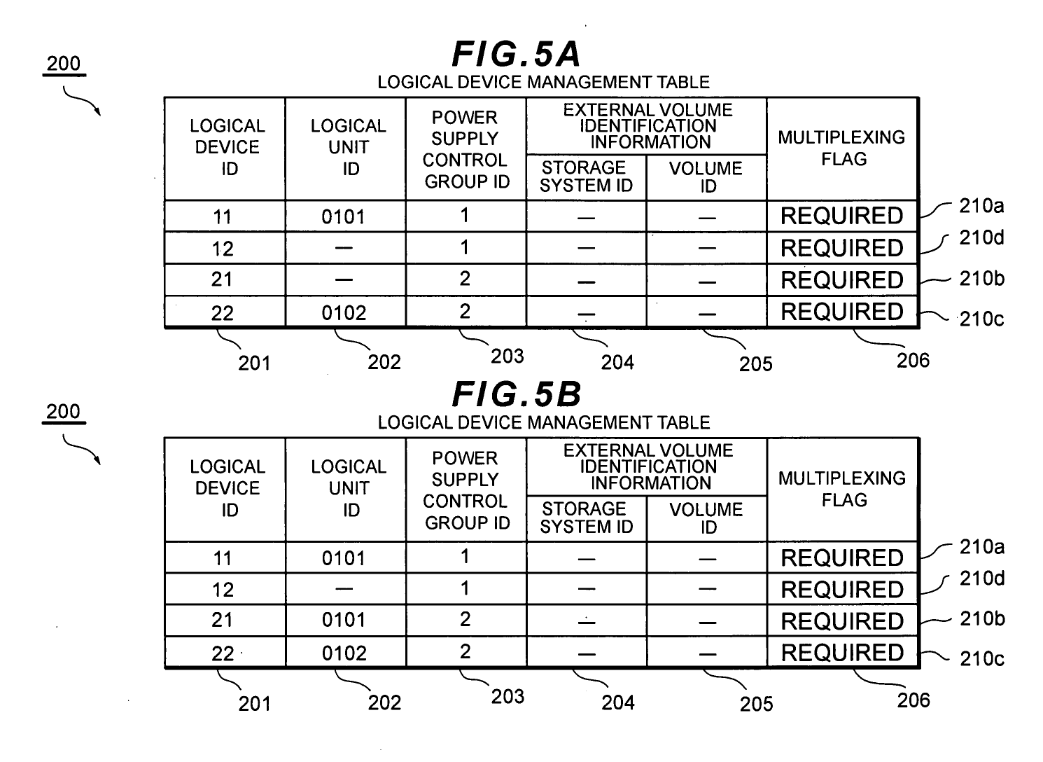

FIGS. 5A and 5B show the configuration of the logical device management table 200. The logical device management table 200 has a plurality of entries 210a, 210b, 210c and 210d. The entry 210a manages the logical device 27a, the entry 210b manages the logical device 27b, the entry 210c manages the logical device 27c, and the entry 210d manages another logical device not shown in the drawings. The entries 210a, 210b, 210c and 210d respectively include a logical device ID 201, a logical unit ID 202, a power supply control group ID 203, external volume identification information (a storage system ID 204 and a volume ID 205), and a multiplexing flag 206.

In the above table, the power supply control group ID 203 is a unique identifier for the power supply control group that includes the disk drives 25 providing a storage area for the logical device 27. The storage system ID 204 is a unique identifier for the storage system 2. The volume ID 205 is a unique identifier for the logical device 27 within the storage system 2. Note that if all logical devices 27 are in the same storage system 2, the storage system ID 204 and volume ID 205 are not necessary. The multiplexing flag 206 shows information indicating whether the logical device 27 requires multiplexing. The value of the multiplexing flag 206 may be set for every disk drive, every logical device, or every storage system, and it may also be specified by users. For example, the multiplexing flag 206 for disk drives 25 composed of high-reliability FC disk drives is set to “not required” while the multiplexing flag 206 for disk drives 25 composed of low-reliability SATA disk drives is set to “required.” If the required multiplicity 102 of a logical unit 28, to which a logical device 27 with the multiplexing flag 206 of “required” is allocated, has been set as “2” or more, the CPU 22 allocates a plurality of logical devices 27 to that logical unit 28 to multiplex it. Note, however, that if all disk drives 25 within the storage system 2 can be recognized as being SATA disk drives, for example from the model name of the storage system 2, the multiplexing flag 206 is not necessarily required.

In the below explanation, if it is not necessary to distinguish entries 210a, 210b, 210c and 210d, just one entry 210 is used.

FIG. 5A shows the logical device management table 200 in the state where just the logical device 27a is allocated to the logical unit 28a, and FIG. 5B shows the logical device management table 200 after a plurality of logical devices 27a and 27b has been allocated to the logical unit 28a. When the required multiplicity of the logical unit 28a is changed from “1” to “2,” the identifier for the logical unit 28a is set in the logical unit ID 202 of the entry 210b that manages the logical device 27b, which is a new logical device allocated to the logical unit 28a.

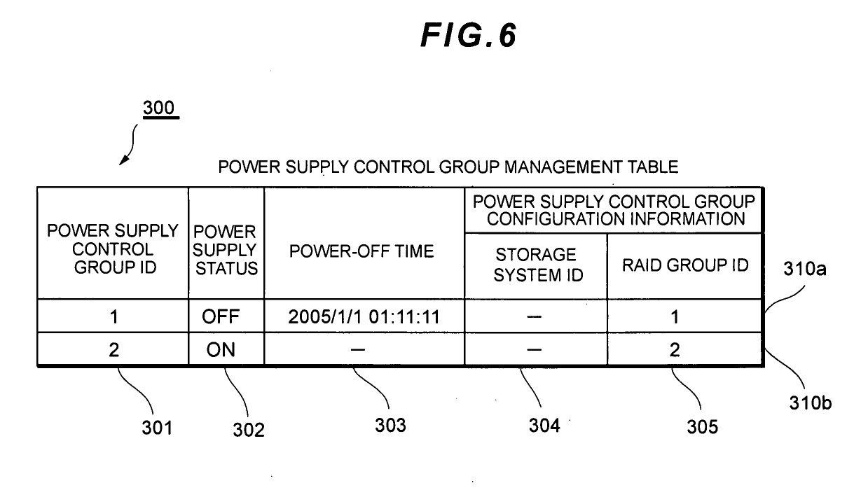

FIG. 6 shows the power supply control group management table 300. The power supply control group management table 300 has a plurality of entries 310a and 310b. The entry 310a manages the power supply control group comprising the RAID group 26a, and the entry 310b manages the power supply control group comprising the RAID group 26b. The entries 310a and 310b respectively include a power supply control group ID 301, a power supply status 302, a power-off time 303, and power supply control group configuration information (a storage system ID 304 and a RAID group ID 305).

In the above table, the power supply control group ID 203 is a unique identifier for the power supply control group that includes disk drives 25 providing a storage area for a logical device 27. The power supply status 302 indicates whether the disk drives 25 included in the same power supply control group are all in a “power-on” or “power-off” state. The power-off time 303 shows the latest time that the power supply for all the disk drives 25 included in the same power supply control group has been turned off. The power-off time 303 is valid only when the power supply status 302 is set to be “power-off.” The storage system ID 304 is a unique identifier for the storage system 2. If all logical devices 27 are in the same storage system 2, the storage system ID 304 is not necessary. The RAID group ID 305 is a unique identifier for the RAID group(s) in the same power supply control group.

In the below explanation, if it is not necessary to distinguish entries 310a and 310b, just one entry 310 is used.

Users may set the required multiplicity for each storage class, in which files, logical volumes, or groups of logical volumes are included. The storage class shows a list of storage attributes, such as a target response time to I/O requests (host access target time) to the relevant files or areas storing the relevant files (directories, etc.), or the necessity of back-up. The CPU 22 assigns a storage area for storing files to a logical volume so that one logical volume does not include files with different storage classes.

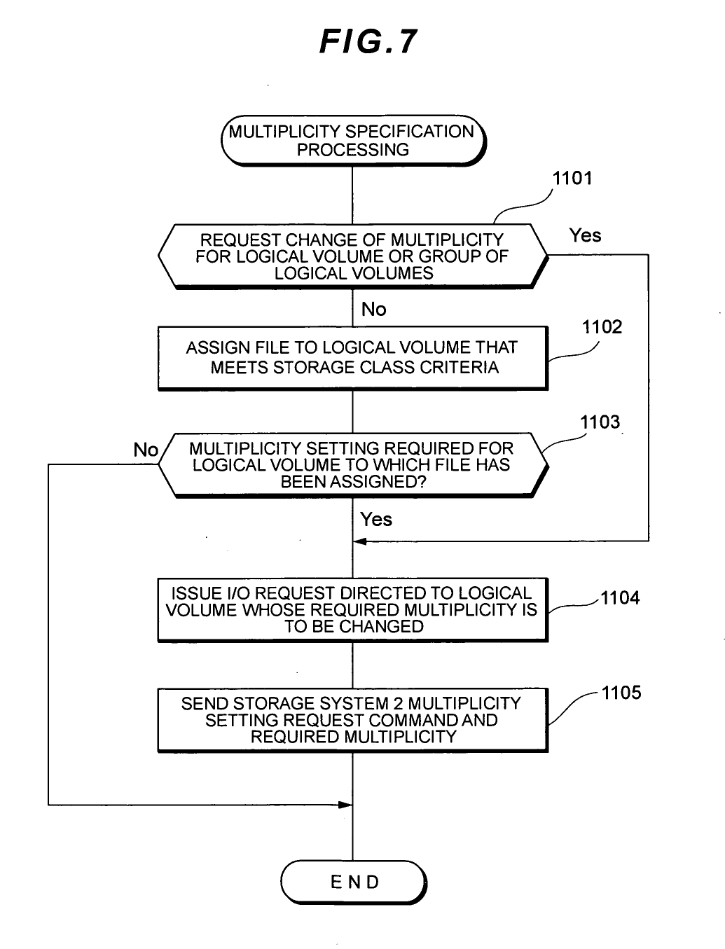

FIG. 7 is a flowchart describing the multiplicity instruction processing executed by the multiplicity instruction processing program 1100. If users have changed the required multiplicity, or established a required multiplicity of more than 2, for a logical volume or a group of logical volumes, or if a file belonging to a storage class with a required multiplicity of more than 2 has been assigned to a logical volume, multiplicity instruction processing is executed.

When the CPU 12 receives a user instruction relating to required multiplicity, the CPU 12 checks whether the received instruction is a request to change the required multiplicity for a particular logical volume or a particular group of logical volumes (step 1101). If the user instruction is a request to change the required multiplicity for any logical volume or any group of logical volumes (step 1101: Yes), the CPU 12 issues an I/O request directed to the logical volume whose required multiplicity is to be changed (step 1104), and then sends the storage system 2 a multiplicity setting request command and the relevant required multiplicity (step 1105).

Meanwhile, if the user instruction is not a request to change the required multiplicity for any logical volume or any group of logical volumes (step 1101: No), but a request for the assignment of a file, the CPU 12 assigns a storage area for storing the relevant file to a logical volume that meets the storage class criteria (step 1102), and checks if multiplicity setting is required for the logical volume to which the storage area for the relevant file has been assigned (step 1103).

If multiplicity setting is required for the logical volume to which the storage area for the relevant file has been assigned (step 1103: Yes), the CPU 12 issues an I/O request directed to that logical volume (step 1104) and sends the storage system 2 a multiplicity setting request command and the relevant required multiplicity (step 1105).

If no multiplicity setting is required for the logical volume to which the storage area for the relevant file has been assigned (step 1103: No), the CPU 12 ends the multiplicity instruction processing.

If the CPU 12 retrieves from the device setting file a logical unit ID corresponding to a logical volume, and sends that retrieved logical unit ID to the storage system 2 together with a multiplicity setting request command and the relevant required multiplicity in step 1105, the storage system 2 can identify the logical volume whose required multiplicity is to be changed, and so, in step 1104, the CPU 12 may issue I/O requests for logical volumes other than the logical volume whose required multiplicity is to be changed.

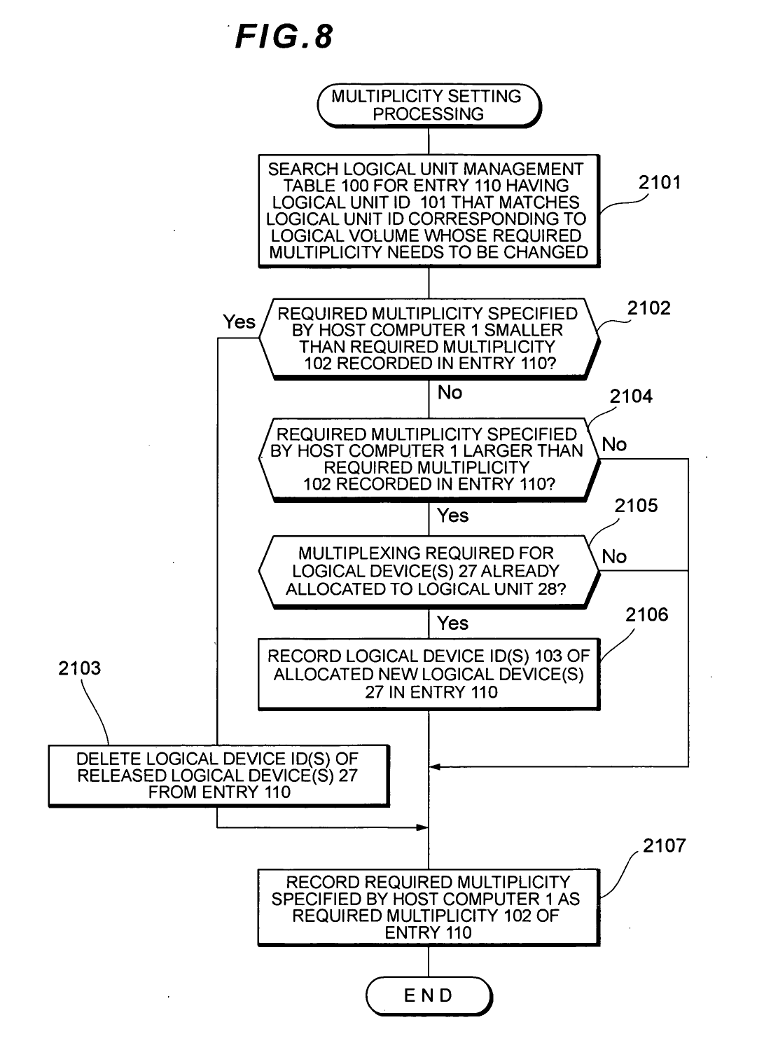

FIG. 8 is a flowchart describing the multiplicity setting processing executed by the multiplicity setting processing program 2100. The multiplicity setting processing program 2100 is executed by the CPU 22 that has received a multiplicity setting request command to change the required multiplicity of a logical unit 28 from the host computer 1, which is connected to the storage system 2 containing that logical unit 28.

The CPU 22 first searches the logical unit management table 100 for the entry 110 having the logical unit ID 101 that matches the logical unit ID corresponding to the logical volume whose required multiplicity needs to be changed (step 2101).

The CPU 22 next checks whether the required multiplicity specified by the host computer 1 is smaller than the required multiplicity 102 recorded in the above entry 110 (step 2102). If the required multiplicity specified by the host computer 1 is smaller than the required multiplicity 102 recorded in the entry 110 (step 2102: Yes), the CPU 22 calls the logical device de-allocation processing program 2300 the same number of times as the difference between the required multiplicity specified by the host computer 1 and the required multiplicity 102 recorded in the entry 110, releases logical device(s) 27 allocated to the logical unit 28, and deletes the logical device ID(s) 103 of the released logical device(s) 27 from the entry 110 in the logical unit management table 100 (step 2103).

The CPU 22 then records the required multiplicity specified by the host computer 1 as the required multiplicity 102 for the entry 110 (step 2107).

If the required multiplicity specified by the host computer 1 is not smaller than the required multiplicity 102 recorded in the entry 110 (step 2102: No), the CPU 22 then checks whether the required multiplicity specified by the host computer 1 is larger than the required multiplicity 102 recorded in the entry 110 (step 2104).

If the required multiplicity specified by the host computer 1 is not larger than the required multiplicity 102 recorded in the entry 110 (step 2104: No), that means the required multiplicity specified by the host computer 1 is equal to the required multiplicity 102 recorded in the entry 110, so the CPU 22 records the required multiplicity specified by the host computer 1 as the required multiplicity 102 for the entry 110 (step 2107).

If the required multiplicity specified by the host computer 1 is larger than the required multiplicity 102 recorded in the entry 110 (step 2104: Yes), the CPU 22 then checks whether multiplexing is required for logical device(s) 27 already allocated to the logical unit 28 (step 2105). This can be checked by referring to the multiplexing flag 206 in the logical device management table 200.

If the logical device(s) 27 already allocated to the logical unit 28 do not require multiplexing (step 2105: No), the CPU 22 records the required multiplicity specified by the host computer 1 as the required multiplicity 102 for the entry 110 (step 2107).

If the logical device(s) 27 already allocated to the logical unit 28 require multiplexing (step 2105: Yes), the CPU 22 calls the logical device multiplex allocation processing program 2200 the same number of times as the difference between the required multiplicity designated by the host computer 1 and the required multiplicity 102 recorded in the entry 110, allocates new logical device(s) 27 to the logical unit 28, and records the logical device ID(s) 103 of the allocated logical device(s) 27 in the entry 110 of the logical unit management table 100 (step 2106), and then records the required multiplicity specified by the host computer 1 as the required multiplicity 102 for the entry 110 (step 2107).

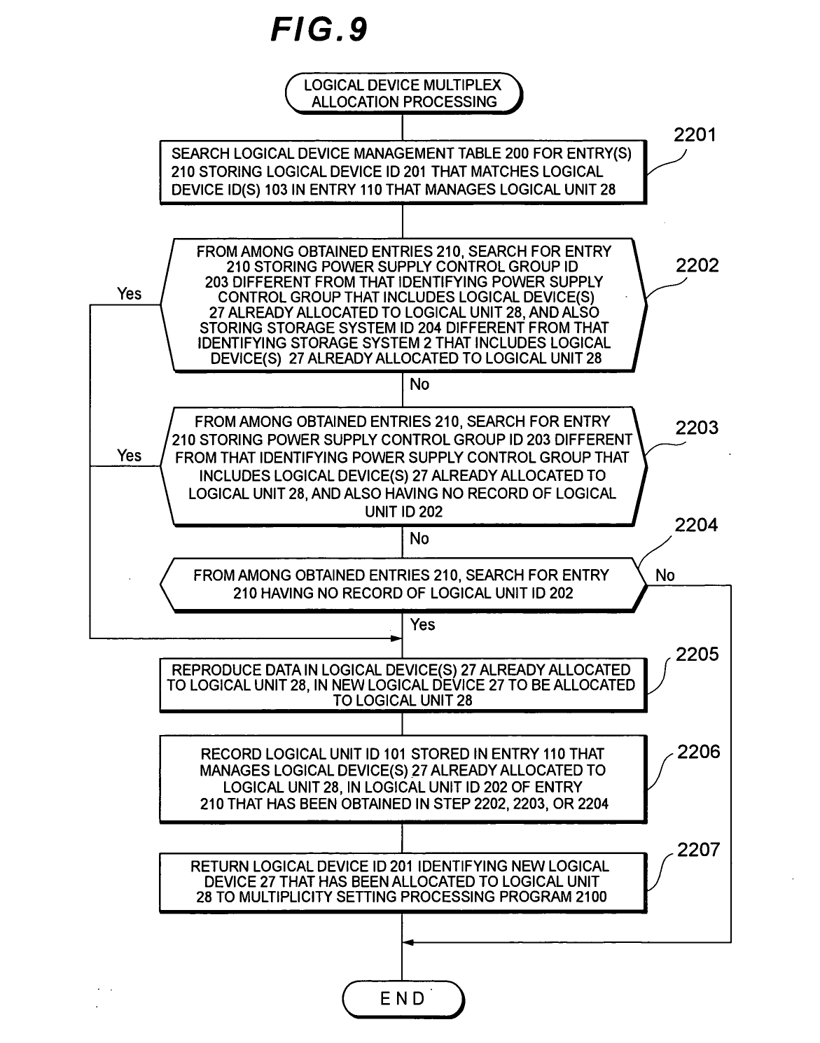

FIG. 9 is a flowchart describing the logical device multiplex allocation processing executed by the logical device multiplex allocation processing program 2200.

The CPU 22 first retrieves the entry 110 that manages the logical unit 28 whose required multiplicity is to be changed, from among the entries 110 recorded in the logical unit management table 100, and then searches the logical device management table 200 for entry(s) 210 storing a logical device ID 201 that matches logical device ID(s) 103 recorded in the above-retrieved entry 110 (step 2201). Taking the case of changing the required multiplicity of a logical unit 28a as an example, the CPU 22 retrieves an entry 110a that manages the logical unit 28a whose required multiplicity is to be changed, from among the entries 110 recorded in the logical unit management table 100. The CPU 22 then searches the logical device management table 200 and retrieves entries 210a and 210b storing logical device IDs 201 that match the respective logical device IDs 103a and 103b, both recorded in the above-retrieved entry 110a.

From among the entries 210 obtained in step 2201, the CPU 22 then searches for an entry 210 storing a power supply control group ID 203 different from the power supply control group ID 203 identifying the power supply control group that includes logical device(s) 27 already allocated to the logical unit 28 whose required multiplicity is to be changed and also storing a storage system ID 204 different from the storage system ID 204 identifying the storage system 2 that includes logical device(s) 27 already allocated to the logical unit 28 whose required multiplicity is to be changed (step 2202). If several entries 210 are obtained in step 2201, the CPU 22 searches for an entry 210 storing a power supply control group ID 203 and storage system ID 204, each being different from any of the power supply control group IDs 203 and storage system IDs 204 of those entries 210.

Taking the case of changing the required multiplicity of a logical unit 28a as an example, from among the obtained entries 210a and 210b, the CPU 22 searches for an entry 210b that stores a power supply control group ID 203 different from the power supply control group ID 203 identifying the power supply control group that includes the logical device 27a already allocated to the logical unit 28a whose required multiplicity is to be changed and also stores a storage system ID 204 different from the storage system ID 204 identifying the storage system 2 that includes the logical device 27a already allocated to the logical unit 28a whose required multiplicity is to be changed.

In multiplexing a logical unit 28a, by retrieving an unallocated logical device 27b that is included in a different power supply control group from that of the logical device 27a already allocated to the logical unit 28a, as described above, the chances that the logical device 27b is in a power-on state increase, even if the logical device 27a is in a power-off state, because of access being made to another logical device 27 (logical device 27c, for instance). Also, by retrieving an unallocated logical device 27b that is included in a storage system different from the storage system 2 including the logical device 27a already allocated to the logical unit 28a, even if a failure occurs in the storage system 2, it is possible to prevent all logical devices 27a and 27b allocated to the logical unit 28 from being unavailable.

If there is an entry 210 that meets the above criteria (step 2202: Yes), the CPU 22 goes to step 2205.

If there is no entry 210 that meets the above criteria (step 2202: No), the CPU 22 searches for an entry 210, from among the entries 210 obtained in step 2201, storing a power supply control group ID 203 different from any power supply control group ID 203 identifying the power supply control group that includes a particular logical device 27 already allocated to the logical unit 28 whose required multiplicity is to be changed, and also having no record of the logical unit ID 202 (step 2203).

If there is an entry 210 that meets the above criteria (step 2203: Yes), the CPU 22 goes to step 2205.

If there is no entry 210 that meets the above criteria (step 2203: No), the CPU 22 then searches for an entry 210, from among the entries 210 obtained in step 2201, that has no record of the logical unit ID 202 (step 2204).

If there is an entry 210 that meets the above criteria (step 2204: Yes), the CPU 22 goes to step 2205.

If there is no entry 210 that meets the above criteria (step 2204: No), the CPU 22 ends the processing.

The CPU 22 then reproduces data in the logical device(s) 27 already allocated to the logical unit 28, in the new logical device 27 to be allocated to the logical unit 28 (step 2205).

The CPU 22 then records the logical unit ID 101 stored in the entry 110 that manages the logical device(s) 27 already allocated to the logical unit 28, in the logical unit ID 202 of the entry 210 that has been obtained in step 2202, 2203, or 2204 (step 2206).

The CPU 22 then returns to the multiplicity setting processing program 2100 the logical device ID 201 identifying the new logical device 27 that has been allocated to the logical unit 28 (step 2207).

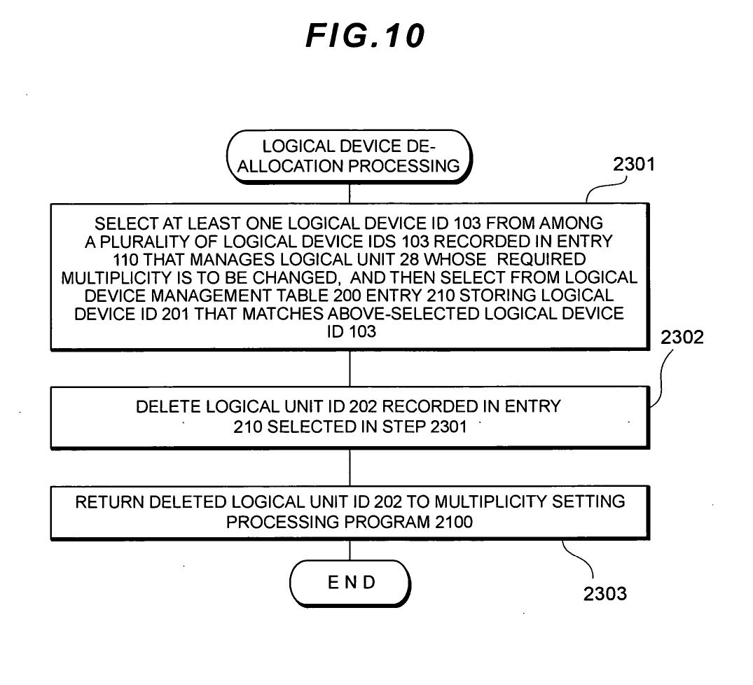

FIG. 10 is a flowchart describing the logical device de-allocation processing executed by the logical device de-allocation processing program 2300.

The CPU 22 first selects at least one logical device ID 103 from among a plurality of logical device IDs 103 recorded in the entry 110 that manages the logical unit 28 whose required multiplicity is to be changed, and then selects entry(s) 210 storing a logical device ID 201 that matches the logical device ID(s) 103 selected above (step 2301).

The CPU 22 then deletes the logical unit ID 202 from the entry(s) 210 selected in step 2301 (step 2302), and returns that deleted logical unit ID 202 to the multiplicity setting processing program 2100 (step 2303).

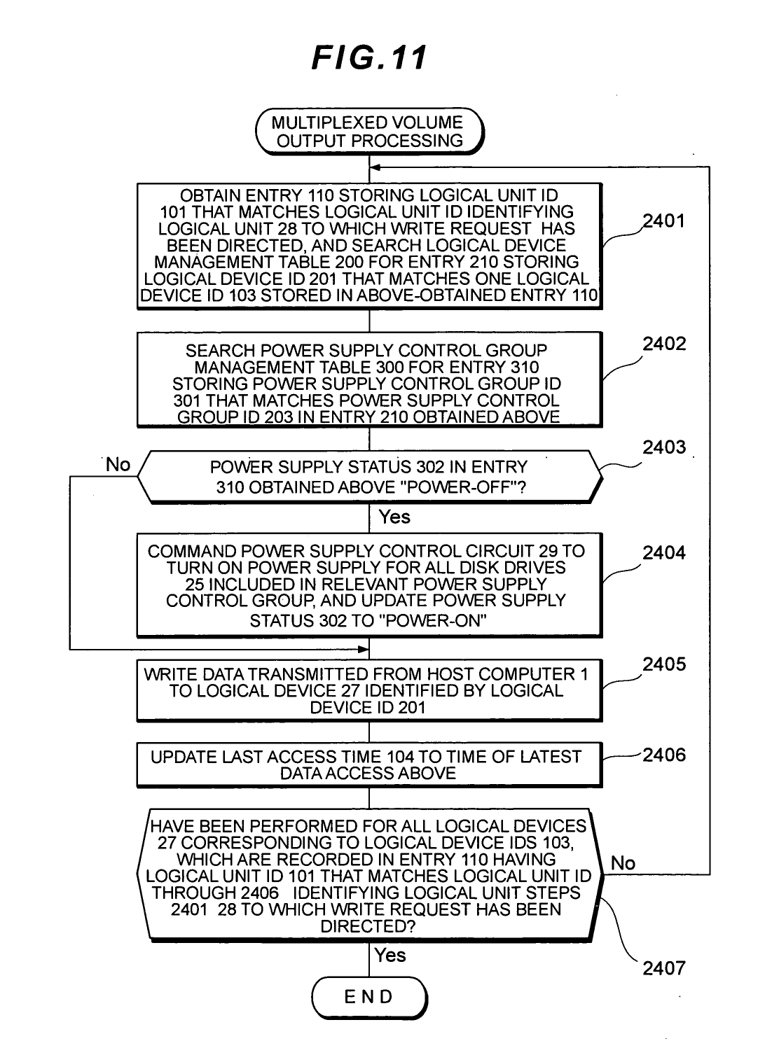

FIG. 11 is a flowchart describing the multiplexed volume output processing executed by the multiplexed volume output processing program 2400.

When the host computer 1 issues a write request directed to a logical unit 28, the CPU 22 obtains the entry 110 storing a logical unit ID 101 that matches the logical unit ID identifying the logical unit 28 to which the write request has been directed, and searches the logical device management table 200 for an entry 210 storing a logical device ID 201 that matches one logical device ID 103 stored in the above-obtained entry 110 (step 2401).

Next, the CPU 22 searches the power supply control group management table 300 for the entry 310 storing a power supply control group ID 301 that matches the power supply control group ID 203 in the entry 210 obtained above (step 2402).

The CPU 22 then checks whether the power supply status 302 in the entry 310 obtained above is “power-off” or not (step 2403). If the power supply status 302 is “power-off” (step 2403: Yes), the CPU 22 instructs the power supply control circuit 29 to turn on the power supply for all disk drives 25 included in the relevant power supply control group, and updates the power supply status 302 to “power-on” (step 2404).

If the power supply status 302 is “power-on” (step 2403: No), the CPU 22 goes to step 2405.

Next, the CPU 22 writes data transmitted from the host computer 1 to the logical device 27 identified by the logical device ID 201 (step 2405), and updates the last access time 104 to the time of the latest data access above (step 2406).

The CPU 22 checks whether steps 2401 through 2406 have been performed for all of the logical devices 27 corresponding to the logical device IDs 103, which are recorded in the entry 110 having the logical unit ID 101 that matches the logical unit ID identifying the logical unit 28 to which a write request has been directed (step 2407).

If steps 2401 through 2406 have not been performed for some of the logical devices 27 corresponding to the logical device IDs 103 recorded in the entry 110 (step 2407: No), the CPU 22 performs steps 2401 through 2406 for those logical devices 27.

Where a plurality of logical devices 27 are allocated to one logical unit 28, one of the logical devices 27 may be defined as a primary logical device and the others as secondary logical devices. In that case, instead of the process in step 2405, the CPU 22 may store difference information indicating which area of the primary logical volume has been updated, and later refer to the difference information and copy difference data from the primary logical volume to the secondary logical volumes before the power supply for the primary logical volume is turned off.

Also, if the off-line time is used as the last access time 104, the process in step 2406 may be substituted with updating the last access time 104, when the host computer 1 makes an off-line request for the logical unit 28, to that off-line time.

Also, if data-write to the logical device 27 ends unsuccessfully in step 2405, the CPU 22 deletes the logical device ID 103 for the unsuccessful logical device 27 from the entry 110, and in order to keep the multiplicity of the logical unit 28, calls the logical device multiplex allocation processing program 2200 and allocates a new logical device 27 to the logical unit 28.

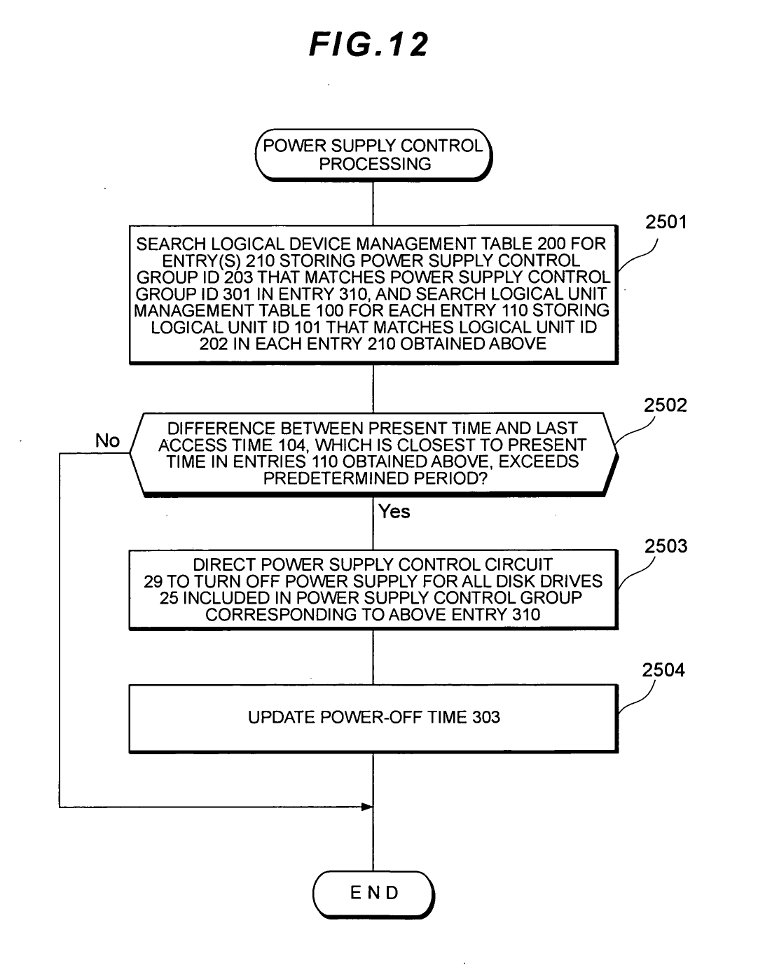

FIG. 12 is a flowchart describing the power supply control processing executed by the power supply control processing program 2500.

For each entry 310 in the power supply control group management table 300, the CPU 22 first searches the logical device management table 200 for entry(s) 210 storing a power supply control group ID 203 that matches the power supply control group ID 301 in the entry 310, and then searches the logical unit management table 100 for each entry 110 storing a logical unit ID 101 that matches the logical unit ID 202 in each entry 210 obtained above (step 2501).

Next, if the difference between the present time and the last access time 104, which is the closest to the present time in the entries 110 obtained above, exceeds a predetermined period (period specified by users) (step 2502: Yes), the CPU 22 instructs the power supply control circuit 29 to turn off the power supply for all disk drives 25 included in the power supply control group corresponding to the entry 310 (step 2503), and updates the power-off time 303 (step 2504).

The power supply control processing is executed at any of the following times: at evenly spaced time intervals; after the multiplexed volume output processing or the multiplexed volume input processing; and in response to an instruction from the host computer 1. If the power supply control processing is executed in response to an instruction from the host computer 1, the CPU 22 can update the last access time 104 to the time that it is instructed to take the relevant logical volume off-line. Also, instead of the above-explained process in step 2502, the CPU 22 can check whether all the retrieved entries 110 have a record of the last access time 104, and if all entries 110 have that record, execute steps 2503 and 2504.

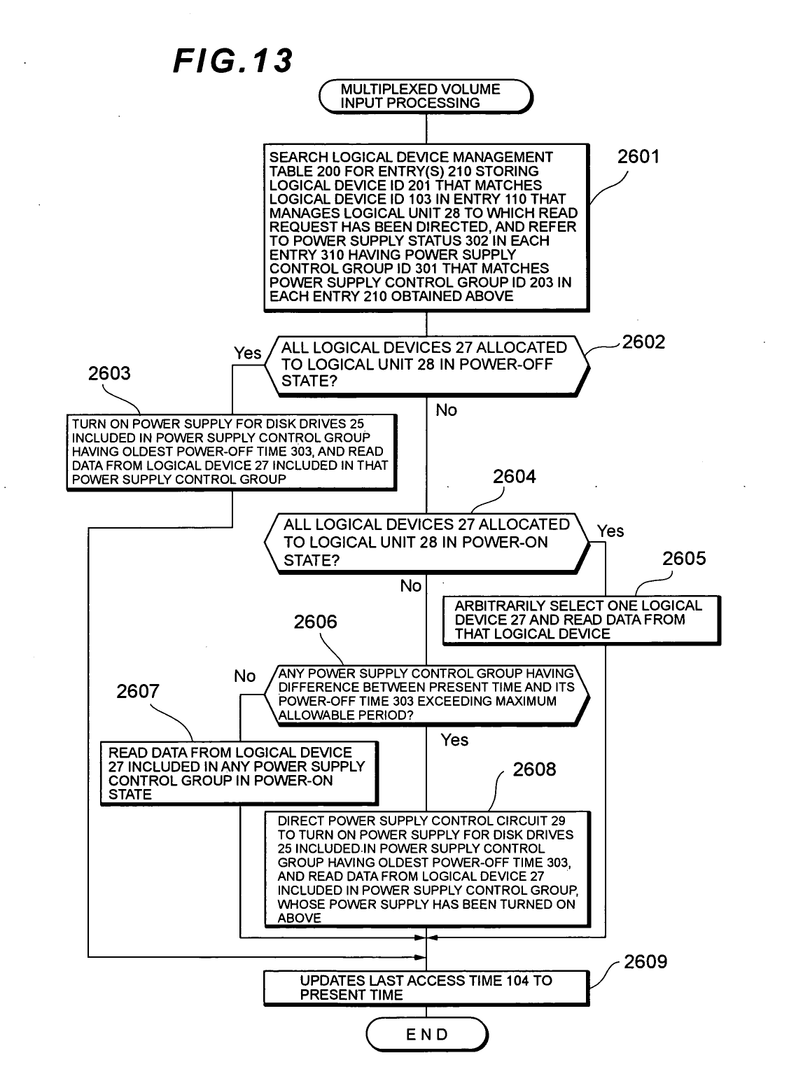

FIG. 13 is a flowchart describing the multiplexed volume input processing executed by the multiplexed volume input processing program 2600.

When a read request from the host computer 1 is directed to a logical unit 28, the CPU 22 searches the logical device management table 200 for entry(s) 210 storing a logical device ID 201 that matches the logical device ID(s) 103 recorded in the entry 110 that manages the logical unit 28 to which the read request has been directed, and refers to the power supply status 302 in each entry 310 having a power supply control group ID 301 that matches the power supply control group ID 203 in each entry 210 obtained above (step 2601).

The CPU 22 then checks whether all logical devices 27 allocated to the logical unit 28 are in a power-off state (step 2602). If all logical devices 27 allocated to the logical unit 28 are in a power-off state (step 2602: Yes), the CPU 22 turns on the power supply for the disk drives 25 included in the power supply control group having the oldest power-off time 303, and reads data from a logical device 27 included in that power supply control group (step 2603).

If some of the logical devices 27 allocated to the logical unit 28 are not in a power-off state (step 2602: No), the CPU 22 checks whether all logical devices 27 allocated to the logical unit 28 are in a power-on state (step 2604). If all logical devices 27 allocated to the logical unit 28 are in a power-on state (step 2604: Yes), the CPU 22 arbitrarily selects one logical device 27 and reads data from that logical device (step 2605).

If some of the logical devices 27 allocated to the logical unit 28 are not in a power-on state, i.e., if some of the logical devices 27 allocated to the logical unit 28 are in a power-on state and the others are in a power-off state (step 2604: No), the CPU 22 refers to the power supply control group management table 300, and checks whether there is a power supply control group having a difference between the present time and its power-off time 303 exceeding the maximum allowable period (step 2606).

If there is no power supply control group having a difference between the present time and its power-off time 303 exceeding the maximum allowable period (step 2606: No), the CPU 22 reads data from a logical device 27 included in any power supply control group in a power-on state (step 2607)

If there is one or more power supply control groups having a difference between the present time and its power-off time 303 exceeding the maximum allowable period (step 2606: Yes), the CPU 22 instructs the power supply control circuit 29 to turn on the power supply for the disk drives 25 included in the power supply control group having the oldest power-off time 303 in the power supply control groups having a difference between the present time and the power-off time 303 exceeding the maximum allowable period, and reads data from a logical device 27 included in the power supply control group, whose power supply has been turned on in the above (step 2608).

The CPU 22 then updates the last access time 104 to the present time (step 2609). If the off-line time is used as the last access time 104, the CPU 22 does not execute the above process in step 2609.

If data read unsuccessfully ends in the above step 2603, 2605, 2607 or 2608, the CPU 22 re-executes steps 2602 through 2609 and reads data from another logical device 27 allocated to the logical unit 28. The CPU 22 de-allocates the unsuccessful logical device 27 from the logical unit 28, and allocates another logical device 27 to the logical unit 28 so that the multiplicity of the logical unit 28 can be maintained.

According to this embodiment, it is possible to reduce the frequency of the power supply for the disk drives 25 being switched on/off, as well as reducing the proportion of the disk drives 25 that have been powered on in the plurality of disk drives 25. As a result, the probability of data loss caused by a failure in the disk drives 25 can be reduced, and low power consumption can also be achieved.

### Embodiment 2

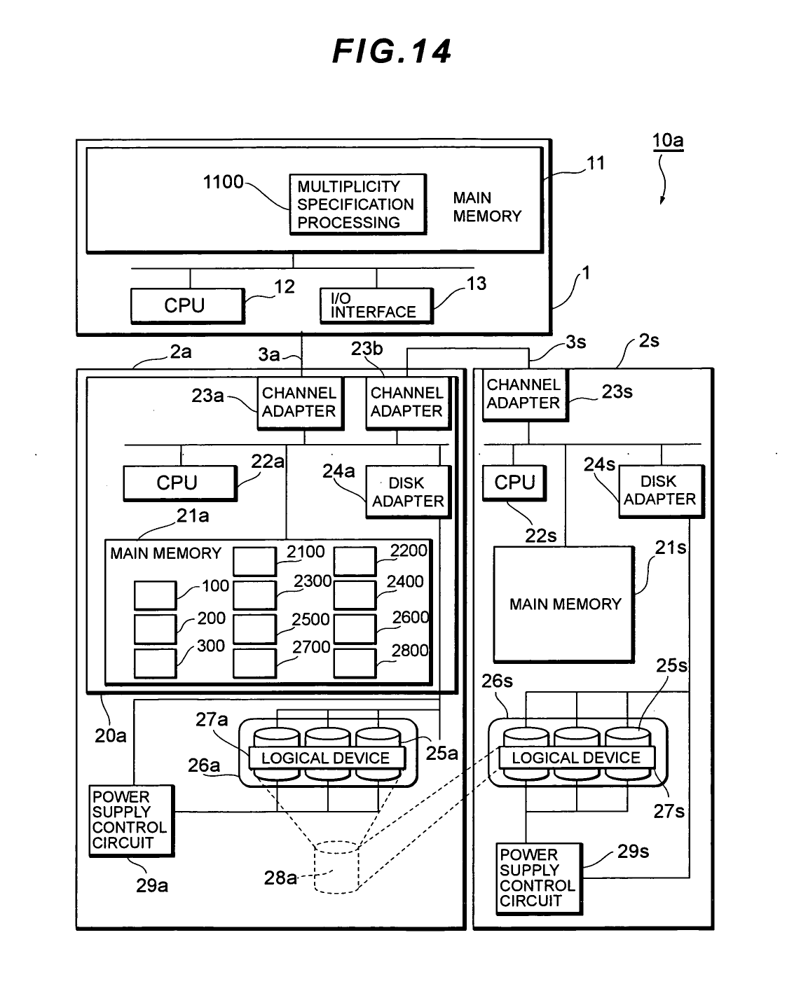

FIG. 14 shows the hardware configuration of a computer system 10a according to Embodiment 2. The computer system 10a includes a host computer 1, a storage system 2a and a storage system 2s. The host computer 1 is connected with the storage system 2a via a communication network 3a. The storage system 2a is connected with the storage system 2s via a communication network 3s.

The storage system 2a includes a controller 20a, a plurality of disk drives 25a, and a power supply control circuit 29a. The controller 20a includes main memory 21a storing various tables, programs, etc., a CPU 22a executing various control processing, a channel adapter 23a functioning as a host interface for connection with the host computer 1, a channel adapter 23b functioning as an initiator port for connection with the storage system 2s that exists externally, and a disk adapter 24a functioning as a drive interface to control data input/output to/from the disk drives 25a.

The main memory 21a stores a logical unit management table 100, logical device management table 200, power supply control group management table 300, multiplicity setting processing program 2100, logical device multiplex allocation processing program 2200, logical device de-allocation processing program 2300, multiplexed volume output processing program 2400, power supply control processing program 2500, multiplexed volume input processing program 2600, storage system addition processing program 2700, and logical device migration processing program 2800. The details of the storage system addition processing program 2700 and logical device migration processing program 2800 are explained later.

A RAID group 26a is defined by grouping logical storage areas provided by each of the plurality of disk drives 25a. A logical device 27a is defined in the storage area of the RAID group 26a.

The storage system 2s includes main memory 21s storing various tables, programs, etc., a CPU 22s executing various control processing, a plurality of disk drives 25s for storing data, a channel adapter 23s functioning as a target port for connection with the storage system 2a that exists externally, a disk adapter 24a functioning as a drive interface to control data input/output to/from the disk drives 25s, and a power supply control circuit 29s that turns on/off the power supply for the disk drives 25s.

A RAID group 26s is defined by grouping logical storage areas provided by each of the plurality of disk drives 25s. A logical device 27s is defined in the storage area of the RAID group 26a.

A logical device 27s in the storage system 2s may be defined as a logical device within the storage system 2a. In defining a logical device 27s as a logical device within the storage system 2a, a “storage system ID for identifying the storage system 2s” will be stored in the storage system ID 204 in the logical device management table 200, and a “logical device ID for uniquely identifying the logical device 27s within the storage system 2s” will be stored in the volume ID 205 in the same table. A logical device 27s may also be defined in a storage area provided by a storage device other than the disk drives 25s (for example, a tape medium or similar).

If the storage system 2s is a system with a controllable power supply (more specifically, a system where the power supply for the disk drives 25s grouped in a particular power supply control group can be turned on/off, and the list of the power supply control groups, the power supply status of each group, and other such information is available), the CPU 22a adds to the power supply control group management table 300 an entry 310 for each power supply control group in the storage system 2s; assigns a power supply control group ID 301 to each power supply control group in the storage system 2s so that each power supply control group in the storage systems 2a and 2s does not have an overlapping power supply control group ID 301; and records a unique identifier for identifying each power supply control group within the storage system 2s in the RAID group ID 305 of the above table.

A logical device 27a, and a logical device 27s, which is in the storage system 2s and defined as a logical device within the storage system 2a, are allocated to a logical unit 28a. In other words, a logical unit 28a is duplexed with a logical device 27a, which is an internal device when viewed from the storage system 2a, and a logical device 27s, which is an external device when viewed from the storage system 2a. As stated above, a logical unit 28a may be multiplexed with any logical devices, regardless of whether they are internal devices or external devices. The host computer 1 can write/read data to/from a logical device 27s in the storage system 2s in the same way as a logical device 27a.

In this embodiment, the steps in the multiplicity instruction processing, multiplicity setting processing, logical device multiplex allocation processing, logical device de-allocation processing, multiplexed volume output processing, multiplexed volume input processing, and power supply control processing are almost the same as those in Embodiment 1. Accordingly, only differences are explained below.

In step 2405 of the multiplexed volume output processing, if the relevant entry 210 sets as its storage system ID 204 a storage system ID identifying the externally existing storage system 2s, the storage system 2a transfers the data received from the host computer 1 to the storage system 2s. Then, the storage system 2s writes the data received from the storage system 2a to a logical device 27s identified by the volume ID 205.

In steps 2603 and 2608 of the multiplexed volume input processing, if the relevant entry 210 sets as its storage system ID 204 a storage system ID identifying the externally existing storage system 2s, the storage system 2a issues a data read request to the storage system 2s, specifying the volume ID 205. Then, the storage system 2s reads data from a logical device 27s corresponding to the volume ID 205 specified by the storage system 2a.

Also, in the above-described steps 2503, 2603 and 2608, the storage system 2a sends to the storage system 2s an instruction to turn on/off the power supply, specifying the RAID group ID 305. Then, the CPU 22s in the storage system 2s instructs the power supply control circuit 29s to turn on/off the power supply for each disk drive 25s constituting the power supply control group corresponding to the RAID group ID 305 specified by the storage system 2a.

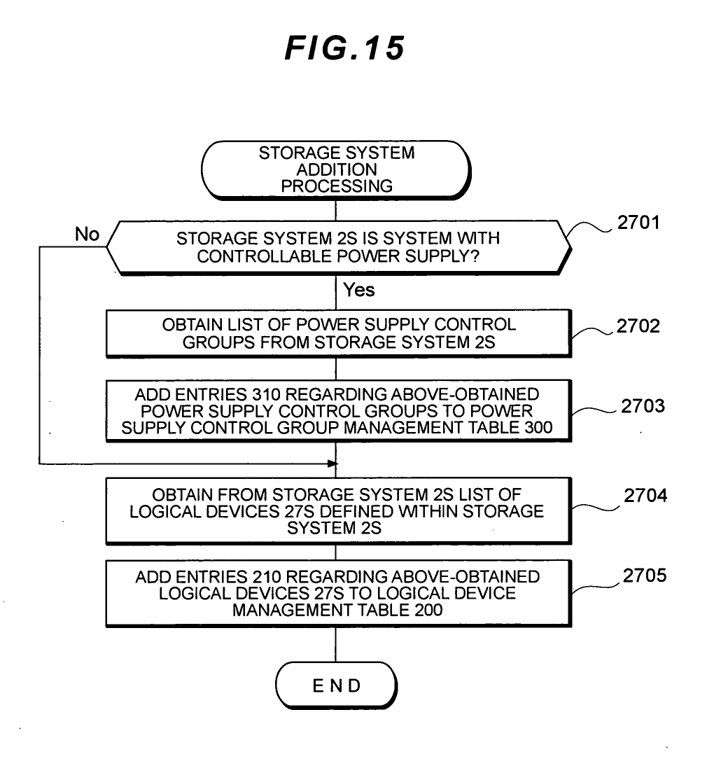

FIG. 15 is a flowchart describing the storage system addition processing executed by the storage system addition processing program 2700.

When a storage system 2s is added onto the storage system 2a, that leads the CPU 22a to check whether the storage system 2s is a system with a controllable power supply (more specifically, a system where the power supply for the disk drives 25s grouped in a particular power supply control group can be turned on/off, and the list of the power supply control groups, the power supply status of each group, and other such information is available), in accordance with the system model number and other such information for the storage system 2s (step 2701).

If the storage system 2s is a system with a controllable power supply (step 2701: Yes), the CPU 22a obtains a list of the power supply control groups from the storage system 2s (step 2702), and adds entries 310 for the obtained power supply control groups to the power supply control group management table 300 (step 2703).

If the storage system 2s is not a system with a controllable power supply (step 2701: No), the CPU 22a goes to step 2704.

The CPU 22a obtains a list of the logical devices 27s defined within the storage system 2s from the storage system 2s (step 2704), and adds entries 210 for the obtained logical devices 27s to the logical device management table 200 (step 2705).

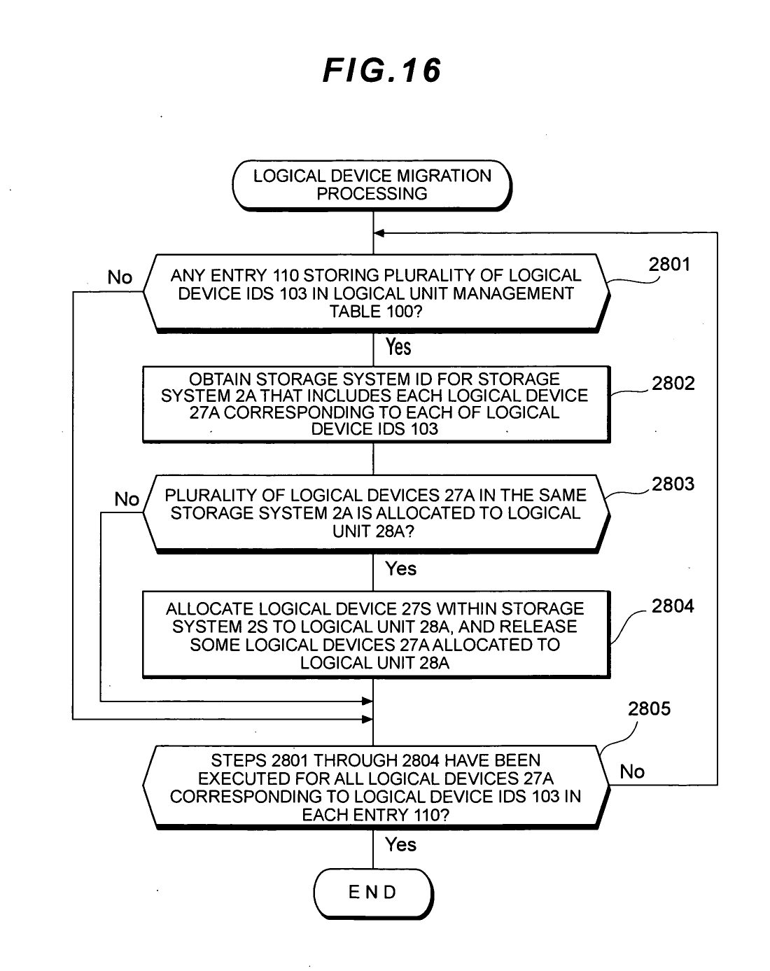

FIG. 16 is a flowchart describing the logical device migration processing executed by the logical device migration processing program 2800. The logical device migration processing is processing executed, where a plurality of logical devices 27a is allocated to a logical unit 28a in the storage system 2a, to migrate some of the logical devices 27a to any logical device 27s within the storage system 2s. The logical device migration processing is executed after the execution of the storage system addition processing.

The CPU 22a first checks whether there is an entry 110 storing a plurality of logical device IDs 103 in the logical unit management table 100 (step 2801). If there is an entry 110 storing a plurality of logical device IDs 103 (step 2801: Yes), the CPU 22a obtains the storage system ID for the storage system 2a that includes each logical device 27a corresponding to each of the logical device IDs 103 (step 2802). More specifically, the CPU 22a searches the logical device management table 200 for entries 210 storing logical device IDs 201 that match the respective logical device IDs 103, and then searches the power supply control group management table 300 for an entry 310 storing a power supply control group ID 301 that matches the power supply control group ID 203 recorded in each of the entries 210 obtained above.

If a plurality of logical devices 27a in the same storage system 2a is allocated to a logical unit 28a (step 2803: Yes), the CPU 22a calls the logical device multiplex allocation program 2200 to execute logical device multiplex allocation processing, allocating a logical device 27s within the storage system 2s to the logical unit 28a, and also calls the logical device de-allocation processing program 2300 to execute logical device de-allocation processing, releasing some of the logical devices 27a allocated to the logical unit 28a (step 2804).

If there is no entry 110 having a plurality of logical device IDs 103 (step 2801: No), or if a plurality of logical devices 27a in the same storage system 2a is not allocated to a logical unit 28 (step 2803: No), the CPU 22a goes to step 2805.

If steps 2801 through 2804 have not yet been executed for some of the logical devices 27a corresponding to the logical device IDs 103 in each entry 110 (step 2805: No), the CPU 22a executes steps 2801 through 2804 for those logical devices 27a.

According to this embodiment, since a logical unit 28 is multiplexed with not only a logical device 27a (internal device) but also a logical device 27s (external device), improved resistance to failure can be achieved.

What is claimed is:

1. A storage system providing a host computer with a logical volume multiplexed with a plurality of logical devices, the storage system comprising:
a plurality of disk drives providing a storage area for the plurality of logical devices;
a read unit for selecting a logical device from which data is to be read in accordance with the power supply status and power-off time for each logical device allocated to the logical volume from which the host computer has requested data-read; turning on a power supply for the selected logical device; and reading data from the selected logical device; and
a write unit for turning on the power supply for each logical device allocated to the logical volume to which the host computer has requested data-write; and performing multiplex-writing for each logical device allocated to the logical volume to which data-write has been requested.

2. The storage system according to claim 1, wherein, in response to a request from the host computer to read data from the logical volume, if the plurality of logical devices allocated to the logical volume from which data-read has been requested is in a power-off state, the read unit selects the logical device having the oldest power-off time from among the plurality of logical devices allocated to the logical volume from which data-read has been requested; turns on the power supply for the selected logical device; and reads data from the selected logical device.

3. The storage system according to claim 1, wherein, in response to a request from the host computer to read data from the logical volume, if some of the plurality of logical devices allocated to the logical volume from which data-read has been requested are in a power-on state, the read unit reads data from any of the powered-on logical devices.

4. The storage system according to claim 1, wherein, in response to a request from the host computer to read data from the logical volume, if the plurality of logical devices allocated to the logical volume from which data-read has been requested is in a power-off state, the read unit selects a logical device having a time difference between its power off time and the time the data read request was received exceeding a predetermined maximum allowable period of time; turns on the power supply for the selected logical device; and reads data from the selected logical device.

5. The storage system according to claim 1, wherein at least a part of the plurality of logical devices allocated to the logical volume is a storage area provided by a storage device included in another storage system that is externally connected to the storage system.

6. The storage system according to claim 1, further comprising:
a multiplicity setting unit for setting the number of logical devices to be allocated to the logical volume in accordance with the storage class of the logical volume or the storage class of a file stored in the logical volume.

7. The storage system according to claim 1, further comprising:
an allocation unit for allocating a plurality of logical devices to a logical volume to which a multiplexing instruction from the host computer is directed.

8. The storage system according to claim 1, wherein each logical device allocated to the logical volume is included in different power supply control groups.

9. The storage system according to claim 1, further comprising:
a power supply control unit for turning on/off the power supply for each disk drive in accordance with how frequently each disk drive is accessed.

10. A storage system providing a host computer with a logical volume multiplexed with a plurality of logical devices, the storage system comprising:
a plurality of disk devices providing a storage area for the plurality of logical drives;
a controller for controlling each disk drive; and
a power supply control unit for turning on/off a power supply for each disk drive in accordance with how frequently each disk drive is accessed,
wherein, when receiving a request from the host computer to read data from the logical volume, the controller selects a logical device from which data is to be read, in accordance with the power supply status and power-off time for each logical device allocated to the logical volume from which data-read has been requested; turns on the power supply for the selected logical device; and reads data from the selected logical device, and when receiving a request from the host computer to write data to the logical volume, the controller turns on the power supply for each logical device allocated to the logical volume to which data-write has been requested; and performs multiplex-writing for each logical device allocated to the logical volume to which data-write has been requested.

11. A method for controlling a storage system that provides a host computer with a logical volume multiplexed with a plurality of logical devices, the method comprising the steps of:
receiving a request from the host computer to read data from the logical volume;
selecting a logical device from which data is to be read in accordance with the power supply status and power-off time for each logical device allocated to the logical volume from which data-read has been requested;
turning on a power supply for the selected logical device; and
reading data from the selected logical device.

12. The method for controlling a storage system according to claim 11, further comprising the steps of:
receiving a request from the host computer to write data to the logical volume;
turning on the power supply for all logical devices allocated to the logical volume to which data-write has been requested; and
performing multiplex-writing for all logical devices allocated to the logical volume to which data-write has been requested.

13. The method for controlling a storage system according to claim 11, further comprising the steps of:
selecting, if the plurality of logical devices allocated to the logical volume from which data-read has been requested is in a power-off state, the logical device having the oldest power-off time from among the plurality of logical devices allocated to the logical volume from which data-read has been requested;
turning on the power supply for the selected logical device; and
reading data from the selected logical device.

14. The method for controlling a storage system according to claim 11, further comprising the step of:
reading, if some of the plurality of logical devices allocated to the logical volume from which data-read has been requested is in a power-on state, data from any of the powered-on logical devices.

15. The method for controlling a storage system according to claim 11, further comprising the steps of:
selecting, if the plurality of logical devices allocated to the logical volume from which data-read has been requested is in a power-off state, a logical device having a time difference between its power-off time and the time the data read request was received exceeding a predetermined maximum allowable period of time;
turning on the power supply for the selected logical device; and
reading data from the selected logical device.

16. The method for controlling a storage system according to claim 11, wherein at least a part of the plurality of logical devices allocated to the logical volume is a storage area provided by a disk drive included in another storage system that is externally connected to the storage system.

17. The method for controlling a storage system according to claim 11, further comprising the step of:
setting the number of logical devices to be allocated to the logical volume in accordance with the storage class of the logical volume or the storage class of a file stored in the logical volume.

18. The method for controlling a storage system according to claim 11, further comprising the step of:
allocating a plurality of logical devices to a logical volume to which a multiplexing instruction from the host computer is directed.

19. The method for controlling a storage system according to claim 11, wherein each logical device allocated to the logical volume is included in different power supply control groups.

20. The method for controlling a storage system according to claim 11, further comprising the step of:
turning on/off the power supply for each disk rive in accordance with how frequently each disk drive is accessed.
